(19) United States
(12) Patent Application Publication
(10) Pub. No.: US 2012/0304095 A1
(43) Pub. Date: Nov. 29, 2012

(54) Identity Manager Operations Dashboard

(75) Inventor: Joseph Mariano Dennis, Tallahassee, FL (US)

(73) Assignee: INTERNATIONAL BUSINESS MACHINES CORPORATION, Armonk, NY (US)

(21) Appl. No.: 13/117,305

(22) Filed: May 27, 2011

(51) Int. Cl. G06F 3/048

(52) U.S. Cl. 715/771

(57) ABSTRACT

A dashboard is provided for use by an operations manager in an enterprise computing environment which receives identity management information from a plurality of information sources by an aggregator portion of an identity management system wherein the identity management system comprises a processor performing a logical process, an electronic circuit, or a combination of a processor performing a logical process and a circuit, aggregates the identity management information according to at least one operations manager preference over a specified snapshot window period of time, creates a graphical user interface containing the aggregation of identity management information; and displays the graphical user interface on a physical, visible display component of a computer system or computing platform.

### CROSS-REFERENCE TO RELATED APPLICATIONS

### Claiming Benefit Under 35 U.S.C. 120

None.

### FEDERALLY SPONSORED RESEARCH AND DEVELOPMENT STATEMENT

None.

### MICROFICHE APPENDIX

Not applicable.

### INCORPORATION BY REFERENCE

None.

### FIELD OF THE INVENTION

The invention generally relates to systems, methods, and computer program products to provide useful aggregation and display of operational information for enterprise computing environments.

### BACKGROUND OF INVENTION

In the general field of enterprise computing, there are two fields of practice referred to as Identity Management (IdM) and Identity and Access Management (IAM). While informally or these terms may be sometimes used interchangeably, in a formal sense there are significant differences between the two fields. The following summarization of the differences between these fields of practice is based upon an article by Matt Pollicove, published Sep. 18, 2009, on the Thoughtplace blogspot. It does not represent the only view of these fields of practice, but makes a fair representation of their differences. The present reader may find other definitions and descriptions within the art useful as well.

According to Pollicove's article, IdM relates to the creation, maintenance and deletion (retiring) of accounts within an enterprise computing environment. These activities may include a degree of automation, especially in the form of “workflow automation”, to allow a series or set of authorities to approve each action. Such actions, for example, may include setting a userAccountControl attribute for an Active Directory.

IAM, on the other hand, is more about controlling physical access to resources within the enterprise computing environment as it relates to users, and necessarily links those access controls to the user's identify. IAM activities may include configuring a user in a multi-factor authentication, configuring a firewall device or single-sign-on (SSO) application, and it might include, in some instances, provisioning to enterprise systems as mentioned above in IdM, and it may provide for population of the Access Management system. In particular, Pellicove summarizes as follows:
“1. IAM is just another system for IdM to manage . . . . 2. IAM is a super-set of IdM . . . . 3. IAM is a completely separate discipline with separate systems . . . .”

There are several types or classes of users of enterprise computing environments. The largest in number, typically, is the “end-user”, who are the individuals who actually want to use the resources of the enterprise, so they are less concerned about the security and access mechanisms, they just want to know how to log onto their accounts and start using applications, directories, databases, etc. Smaller in number are the administrators (admins) who are responsible for adding new end-users to the enterprise (e.g. assigning user id's and passwords, provisioning access permissions to application programs, databases, directories, etc., and enforcing certain security policies according to the role of each end-user), for removing existing end-users upon their departure from the organization, and for revising these permissions of end-users upon a change in their role within the organization. Then there is a third type of user of the enterprise known as operations managers who deal less with the administrative tasks, but instead are responsible for overseeing the computing enterprise from an operational perspective of how the resources are being used (too much, too little?), whether or not the enterprise is meeting its intended objectives (are results too slow or too fast, accurate or imprecise, etc.), and are continuity of service plans adequate in case of failure of one or more components in the enterprise.

### SUMMARY OF THE INVENTION

A dashboard is provided for use by an operations manager in an enterprise computing environment which receives identity management information from a plurality of information sources by an aggregator portion of an identify management system wherein the identity management system comprises a processor performing a logical process, an electronic circuit, or a combination of a processor performing a logical process and a circuit, aggregates the identity management information according to at least one operations manager preference over a specified snapshot window period of time, creates a graphical user interface containing the aggregation of identity management information; and displays the graphical user interface on a physical, visible display component of a computer system or computing platform.

### BRIEF DESCRIPTION OF THE DRAWINGS

The description set forth herein is illustrated by the several drawings.

FIG. 1 provides an example and details of a graphical user interface which depicts an operations dashboard according to the present invention.

FIG. 2 provides more details of the data feeds portion of the graphical user interface of FIG. 1.

FIG. 3 provides more details of the workflow system interface portion of the graphical user interface of FIG. 1.

FIG. 4 provides more details of the reconciliation activity portion of the graphical user interface of FIG. 1.

FIG. 5 provides more details of the performance monitoring portion of the graphical user interface of FIG. 1.

FIG. 6 sets forth a functional block diagram of a system according to the present invention

FIG. 7 illustrates at least one logical process according to the present invention.

FIG. 8 depicts a generalization of a computing platform suitable for implementation of the present invention with a logical process, specialized circuit, or combination of logical process and circuit.

### DETAILED DESCRIPTION OF EMBODIMENT(S) OF THE INVENTION

The inventors of the present invention have recognized a problem not yet recognized by those skilled in the relevant arts. Today, using the available GUIs on IAM/IdM systems which are designed with admins and end-users in mind, an operations manager must navigate to several GUI panels and even sift through systems logs to get the full operational picture for the previous day's activities. Embodiments according to the present invention addresses alleviates this shortcoming in the art by providing a centralized activities presentation with an improved the user experience from an operations management perspective.

For example, IBM's Tivoli™ Identity Manager (TIM) currently provides two “out-of-the-box” Graphical User Interfaces (GUIs) to facilitate user interaction: a Self-Service Console which is intended for general end-user activities, and an Administrative Console which provides System Administration functions. Both GUIs are configurable from a functional perspective; that is, they provide control of which menu options are presented to a user. Additionally, each GUI can be minimally customized to render slight variances of the look-and-feel. Similar competitive identity management products allow for similar GUI options, such as but not limited to products from Computer Associates (Netegrity), BMC, Microsoft, Novell, Oracle, as well as “open” IdM/IAM solutions from MIT Kerberos, Open LDAP, etc.

A problem arises, however, from the limited extent to which the GUIs can be customized, especially from an operations perspective. Operations managers with operational responsibilities for an IdM or IAM system have specific needs that are quite unlike the typical end-user or system admin. These operations managers must be able to see all aspects of IAM/IdM systems operability from a centralized, high level presentation.

Today, using the available GUIs on IAM/IdM systems which are designed with systems administrators and end-users in mind, an operations manager must navigate to several GUI panels and even sift through systems logs to get the full operational picture for the previous day's activities, for example.

After recognizing this problem by the present inventors, a new “dashboard” described herein is provided which is especially suitable for use by operations managers which aggregates IAM/IdM information relative to daily operations of an enterprise computing environment from different and disparate endpoints, tables, and logs, and redirects this information to one dashboard GUI tailored to present a snapshot of a specific operations time interval, such as the last twenty-four hours.

Embodiments of the invention may aggregate IAM/IdM information from a variety of identity management systems provided by a range of suppliers. In at least one available embodiment, the redirection of information is mostly accomplished by leveraging the standard Tivoli Identity Management (TIM) application programming interface (API) set to extract the desired information from TIM related resources and endpoints and other native API sets to collect data from the disparate sources, and to present it on a custom dynamically created web page, such as a JAVA™ Server Page (jsp) panel. It will be understood by those skilled in the art, however, that this example embodiment is provided for illustration purposes only, whereas he full range of embodiment options according to the invention include similar processes and functionality interfaced to and interoperational with IAM and IdM systems from other suppliers as well.

Further enhanced embodiments of the present invention may aggregate and present additional information gathered by monitoring agents deployed to end-user and admin consoles, as well as additional information obtained from other third-party products such as ticketing or collaboration applications.

Systems and methods according to the present invention, therefore, collect IdM- and IAM-related operations data from various sources and present them at a high level in a centralized user interface, which we will refer to as the operations dashboard. The intended audience or user base for this dashboard does not need to have a high degree of technical skills, and may include operations managers, IT managers, and service owners such as PeopleSoft™ managers. The graphical user interface provided by embodiments according to the present invention preferably does not require programming on the operations manager's part, but instead provides for configurability of adding and deleting items from the GUI, as well as preferably some abilities to arrange the positions of the displays of the added items in the GUI. This minimal layout configurability and add/delete “what is shown” configurability would preferably be similar to the capabilities of the of the “out of the box” (non-operations-manager-friendly) GUI's previously described.

The typical IdM- and IAM-related information for which the intended audience could be interested and would be aggregated and presented, includes: (a) source data feeds including the Authoritative Source of Record (ASOR) information and other auxiliary feeds, (b) reconciliations of end points (managed targets), account activity, (c) interface activity such as requests sent to ticketing, collaboration or badging systems, and (d) performance information such as bottlenecks below established thresholds. Authoritative System of Record (ASOR) is the source repository of “person” (user) data used as the authority over all other sources in the enterprise. ASORs are most often Human Resources (HR) or Enterprise Resource Planning (ERP) data such as that which is found in PeopleSoft™ systems, and which can be fed into systems such as TIM. Reconciliation, as referred to herein, is a TIM term used to describe the process by which the TIM system “discovers” what accounts and “supporting data” exist on each endpoint. The accounts and supporting data are returned and stored in the TIM repository. TIM uses this data to determine whether people's accounts are in compliance with established policies. For instance, TIM reconciles Active Directory and returns all the accounts and groups for a given AD domain. Other identity management systems from other suppliers may have analogous functionality and information, even if by another name, which may be incorporated into the dashboard of various embodiments according to the invention.

The operations dashboard is intrinsically configurable, according to at least one embodiment, with regards to standard inputs provided by the ITIM system such as data feeds and reconciliations of managed targets. Configuring inputs from Tivoli Monitoring and any custom interface components would require more customized configuration. Data elements presented on the dashboard provide hyperlinks to the respective, detailed information behind the numbers and statistics.

For further enhancement, the present inventors suggest embodiments which include the use of color or animated text (flashing, pulsing, etc.), such as red text (or background) to indicate a failure to obtain data during the review period, yellow to indicate a possible problem with the data, and green to indicate data which is likely very reliable and complete.

Graphical User Interface “Dashboard”.

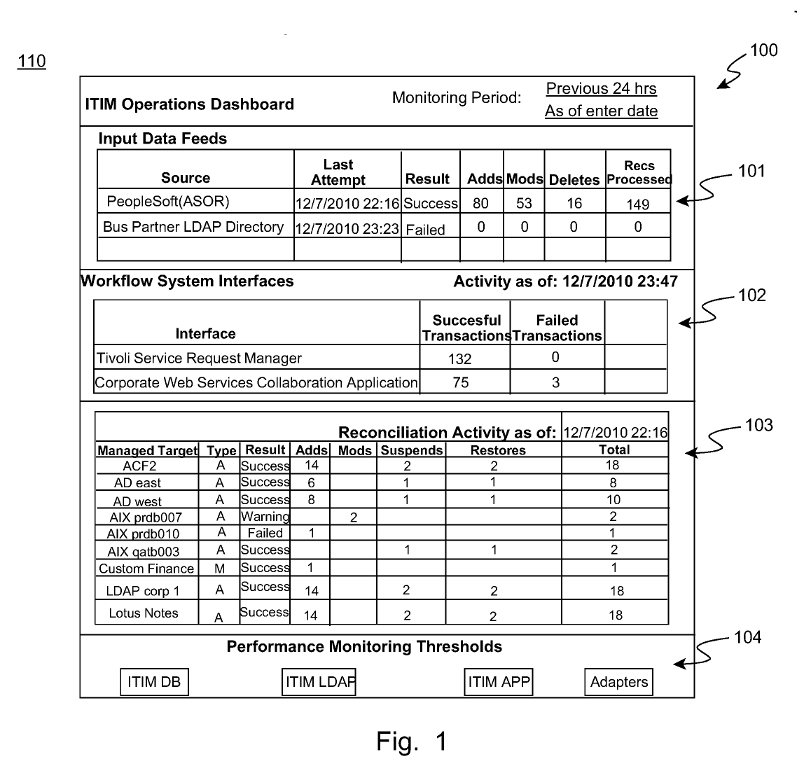

In FIGS. 1 through 5, a Graphical User Interface (100) shown on a portion (110) of a physical display component of a computing platform or computer system is shown according to at least one embodiment of the invention. Turning to FIG. 1, the GUI (100) includes, in this instance, four areas of aggregation and display: aggregation of the several data feeds (101), aggregation of the information gathered from one or more workflow interfaces (102), consolidation of reconciliation reports (103), and an area for aggregation and optionally links to performance monitoring results (104).

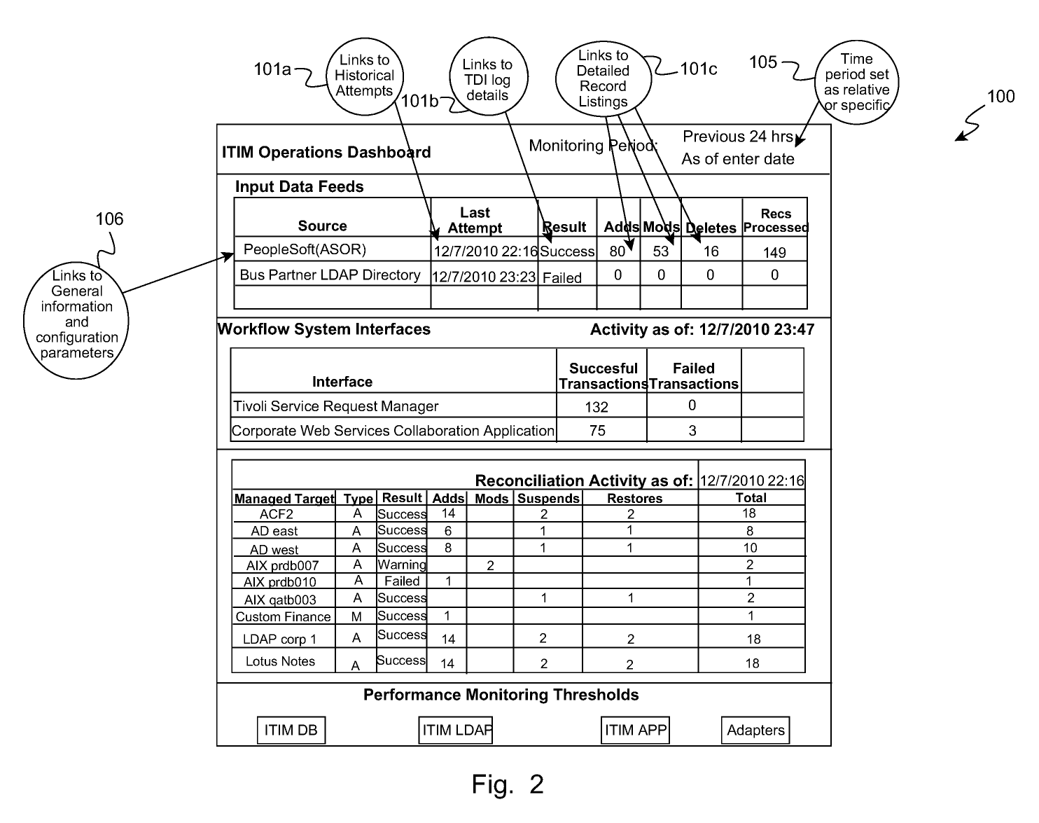

Turning now to FIG. 2, the same GUI (100) is shown with additional reference or explanatory information regarding certain aggregated and displayed information regarding the snapshot window and the data feed aggregation area (101). There are one or more selectable links to general information and configuration parameters (106) such as links to PeopleSoft ASOR records and business partner lightweight directory access protocol (LDAP) configuration parameters. Historical attempts to access this information is preferably shown (101a) to provide the operations manager the ability to see the “freshness” or “staleness” of the information, including indicators (101b) whether or not the most recent attempt(s) were successful. Lastly, one or more links (101c) including a summary of the number of additions, modifications, deletions, and records processed may be provided. Any of the linked information may be selected, such as by clicking with a mouse pointer, to allow the operations manager to “drill down” to the underlying reports or statistics from the particular source(s) represented in the aggregated display. Use of hyperlinks within this dynamically generated JAVA™ Server Page is one available way to realize such active display information. Finally, within the GUI (100) is shown the time period (snapshot window) over which the information has been aggregated. This information is also preferably hyperlinked to one or more additional GUI's which would allow the operations manager to change the snapshot window value.

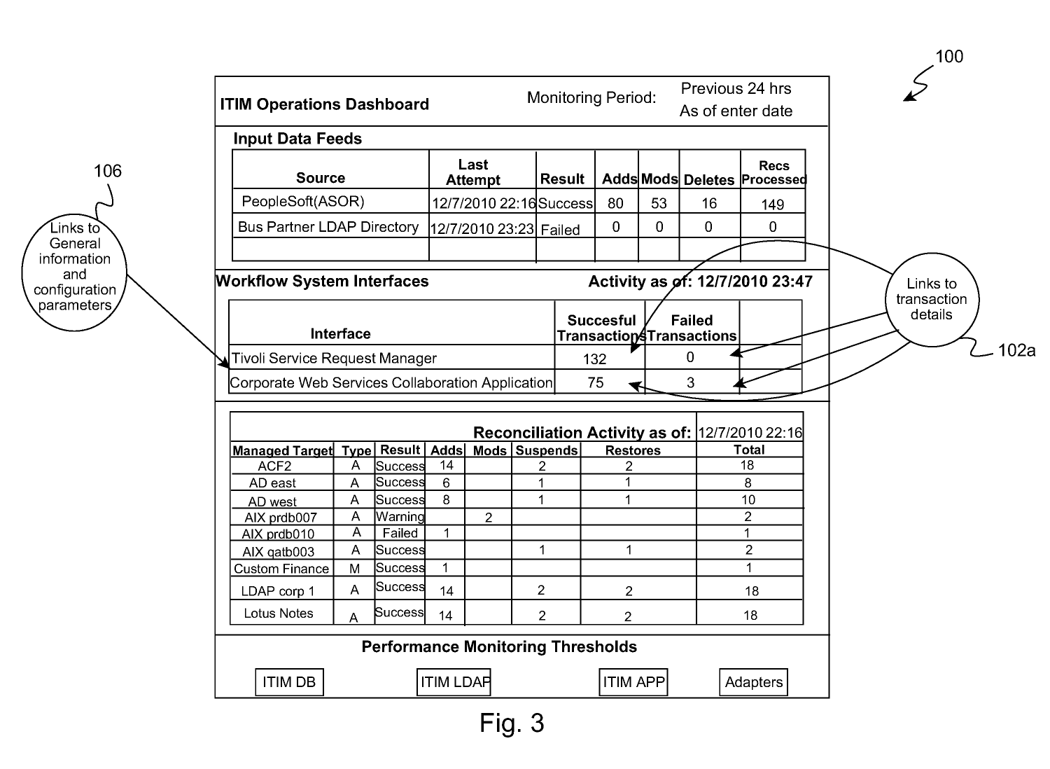

Turning now to FIG. 3, the workflow operations area (102) of the GUI (100) is provided with greater annotation for the reader's reference. Again, there are linked indicators (106) showing one or more workflow systems to which the embodiment of the invention is interfaced, and indicators of the aggregated number of successful and failed transactions (102a) handled by the workflow systems. As previously discussed regarding hyperlinks in the data feed area (101) of the GUI (100), the linked information (106, 102a) preferably provides a quick and easy way for an operations manager to drill down into more GUI panels, frames, windows or dialog boxes for each of the represented workflow systems in order to view underlying data, log files, and configuration options of those systems.

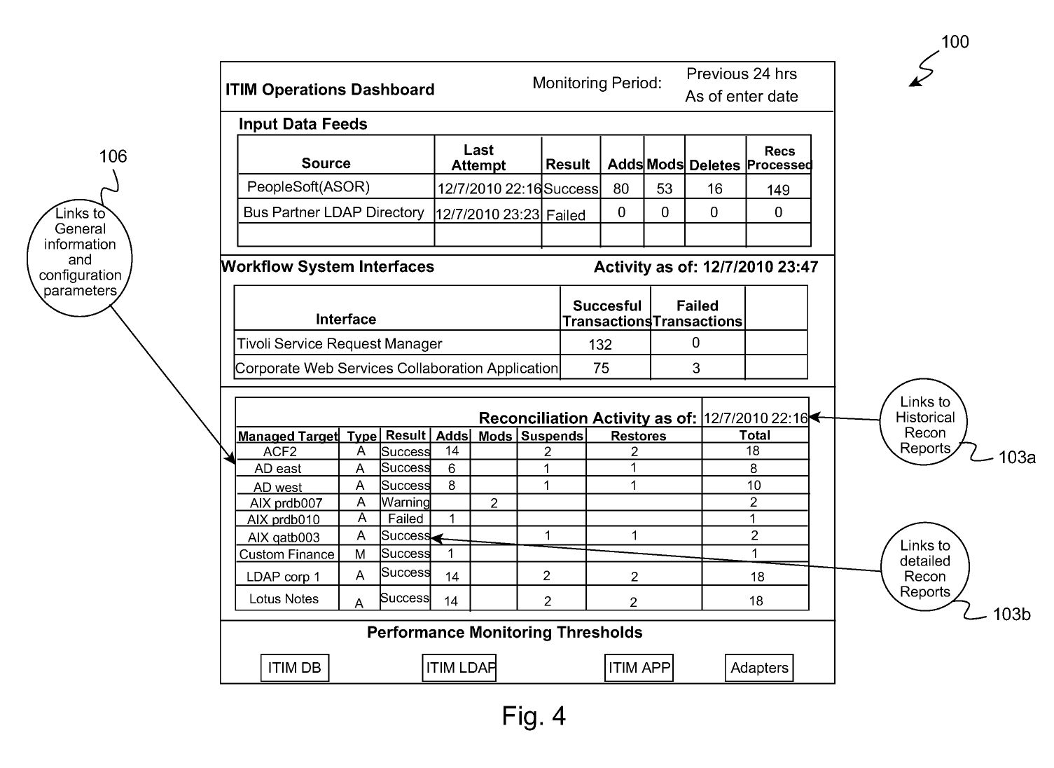

Now referring to FIG. 4, the reconciliation aggregation area (103) of the GUI (100) is provided with annotations including links to configuration screens and underlying data (106) for the managed target systems, the results (103b) of the gathering attempts by the embodiment of the invention, preferably one or more statistics regarding additions, modifications, suspensions, and restoration activities, and links to the historical reconciliation reports (103a) aggregated and summarized in this area (103).

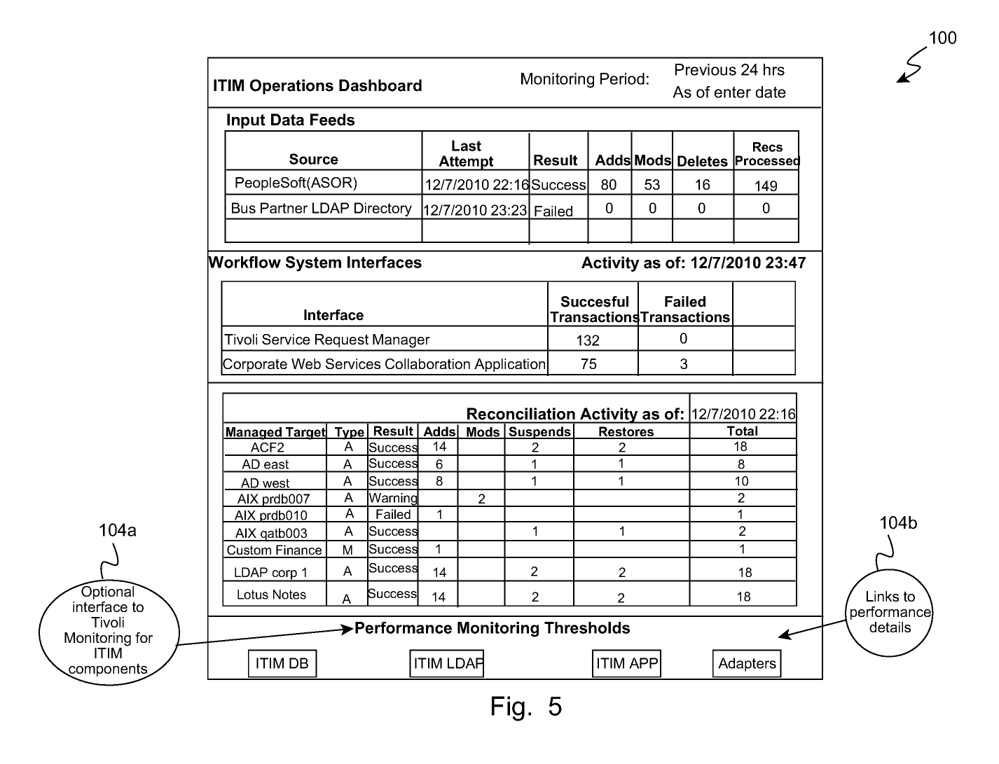

Finally, in FIG. 5, the performance aggregation area (104) is shown according to this example embodiment in which one or more links (104b) to performance monitoring systems, such as IBM Tivoli Identity Management (ITIM) database, LDAP, applications, and adapters, are optionally (104a) provided.

System Design and Operations.

As embodiments of the present invention may take the form of automated methods, computer readable memory devices storing program code to perform the logical processes described here, a system, or any combination of automated method, memory devices and system(s), the following system description is provided with the understanding that it is within the skill in the art to exchange electronic circuits with processors executing program code and vice versa.

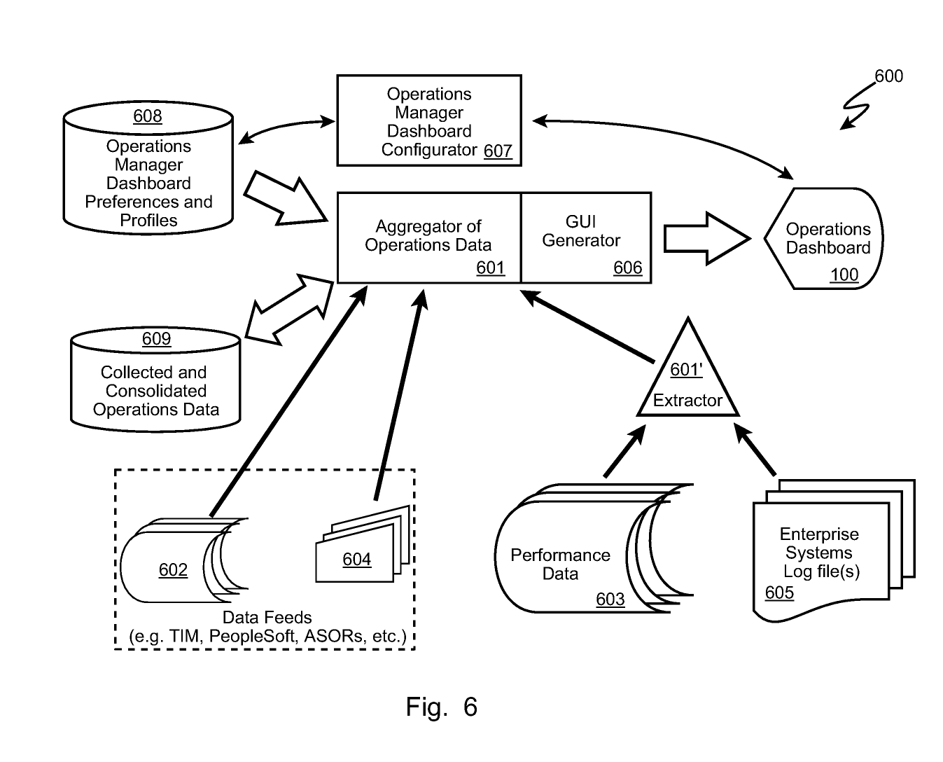

In FIG. 6, a functional block diagram (600) of computing systems components in an arrangement according to at least one embodiment of the present invention is shown. Each of these components may be a processor executing a logical process, a specialized circuit, or a combination of processor, logical process, and electronic circuit. The aggregator (601) interfaces to, or incorporates, an extractor (601′) which may retrieve and extract certain useful data from one or more of performance data logs (603), and other enterprise system log files (605). Such retrieved and extracted data may be received through any appropriate information receiver, such as program code executed by a processor to read a data structure in a memory device, or a computer network interface such as Ethernet, Bluetooth, WiFi, LAN, etc. This received information is then used by the aggregator, and optionally stored (609) in an aggregation data store. Similarly, one or more data feeds (602), such as ASOR's (604), are received by the aggregator (601), and optionally stored (609). Connection definitions for the various inputs (602, 603, 604, and 605) are preferably stored in one or more preferences and profiles (608) so as to allow each operations manager to configure more or less aggregation of source information.

According to the preferences and profiles (608) for a particular operations manager, the aggregator (601) then uses the received, stored, or a combination of received and stored data to prepare the operations dashboard for display via a GUI (100), such as the GUIs previously described. The main logical operations of the aggregator is to summarize the information, such as counting total additions, deletions, modifications, etc., as previously discussed with reference to the GUI (100). The aggregator may be a processor executing program code to perform the previously described data combinations, filtering, and statistical analyses, it may be an electronic circuit to perform the same functions, or a combination of processor, program code, and electronic circuit(s)

A user interface generator (606) is provided cooperative with the aggregator (601) to programmatically generate a displayable GUI as previously described, such as by dynamically creating a hypertext markup language (HTML) page containing links to the underlying sources of information (602, 603, 60, 605) and the stored information (609). Such programmatic generation of browser pages can be accomplished by a computer system with a processor executing program code, such as Java™ Server Pages (jsp), C++, or similar programming languages and techniques, and the generated pages may be HTML with one or more of several types of server side scripting such as the aforementioned JSP™, Hypertext Preprocessor (PHP), Perl, Active Server Pages (ASP), Microsoft's ASP.NET™, etc. Alternate embodiments may include electronic circuits to render such displayable pages, or a combination of processor, programming code, and electronic circuits.

Additionally, certain links may be provided by the user interface generator (606) to configuration APIs of these systems which created this source information, as well as to provide for operations managers to modify (607) their dashboard preferences and profiles (608), such as by adding a monitored system to any area of the GUI (100) and changing the snapshot window parameter. Connections may be defined and retrieved by the UI generator (606) programmatically, such as to and from a properties file, table, or similar method.

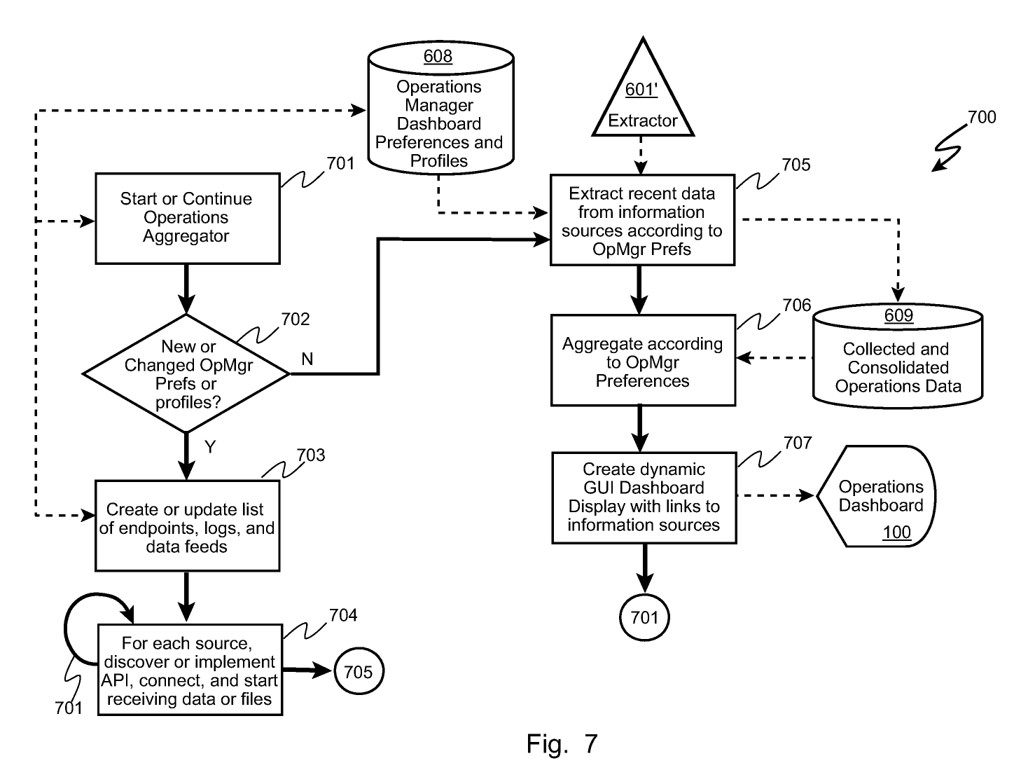

FIG. 7 depicts a logical process (700) according to one embodiment of the invention which may be realized by a processor executing a logical process, or by an electronic circuit, or by a combination of processor, logical process, and electronic circuit. The process starts (701) by initializing a list (703) of endpoints, log files, and data feeds to aggregate into a dashboard display by discovering or implementing an API for each information source according to the operation's managers preferences and profile (608), connecting or subscribing to that source, and starting to receive data or files from each information source. For example, at the high level, operations manager's preferences may involve which “areas of aggregation” the operations manager desires to have on the dashboard, such as data feeds, workflow interfaces, reconciliations, monitoring, or any other aspects not included in sample embodiment. A certain operations manager may not be interested, however, in all aspects of operations or may want to focus only on one area, so the configuration may allow for suppressing certain details from display. At the low level, the operations manager may be only interested in UNIX endpoints; therefore, he or she could configure the reconciliation section to only report on UNIX serves.

Then, during operation, historical and most recent data is extracted (705) from the listed information sources according to the operations manager's preferences and profile (706), and that information is aggregated (706) as previously described and exemplified. Aggregation may include, but is not limited to:
(a) averaging statistics and counts over the snapshot window period of time for each linked source;
(b) averaging statistics and counts over the snapshot window period of time across several linked sources (e.g. similar systems or similar information sources);
(c) weighting or prioritizing statistics and information from some sources greater than from other sources (e.g. due to reliability, freshness, etc.);
(d) preempting some displays by other displays according to a logical rule, weight or priority; and
(e) changing the color, format or display mode of text and numbers (italics, bold, steady, flashing, etc.).

These, as well as other possible aggregation options, are preferably provided to the operations manager via a separate user interface for setting of the operations manager's preferences and profile without requiring the operations manager to perform programming.

Next, a dashboard display GUI (100), such as a dynamically created jsp page with links to the underlying source information, is generated (707) and displayed on a physical, visible display of a computer system or computing platform. Then, the logical process (700) continues (701) to look for changes to operations manager preferences (702), update the list and connections to information sources (703, 704), extract (705), aggregate (706), and display (707) as previously disclosed.

Configuration by the Operations Manager.

In at least one embodiment according to the present invention, a operations manager may configure the dashboard interface and the aggregator through the setting of the preferences and creation of the profile. In this embodiment, there are two types of configuration and profile settings: (1) base (or technical) configuration and (2) user configuration. The former is provided and performed where the base utility and available user configurations need to be configured or customized and deployed by a reasonably technically skilled person. This configuration effort may involve setting up interfaces, defining data categories, and defining the set of attributes, fields, log data, etc. to bring in from each source.

In the latter (e.g. user configuration), certain choices and preferences may be adjusted and set by an operations manager after the dashboard and aggregator have been implemented according to customer requirements. During user configuration, the end user (e.g. an operations manager) is provided the ability to pick and choose from an already-configured set of aggregation categories (data feeds, workflows, reconciliation reports, etc) and from specific items of interest per category (feed1, feed2, end point a, endpoint b, etc). The user may also select specific information, attributes, fields, etc from the superset defined by the base customization. Such choices may be driven off a menu item from the dashboard or a configuration utility.

Aggregation and Filtering Rules.

As previously mentioned, a wide variety of rules and analytical processes for aggregating and filtering the information by the aggregator may be realized in various embodiments according to the invention. In at least one embodiment, majority of the inputs are dependent on how the IdM system (e.g. TIM) typically provides the information. Filtering is, in such a case, defined and configured in two stages; for instance, initially during the base configuration, the technician configures feed #2 to bring in a set of 10 attributes from a possible of 15 attributes, and later, an end user can refine his or her desired set of aggregated and displayed attributes down to five of the 10 attributes by selecting the five off the menu list of the 10 attributes.

In this manner, a user interface for operations managers which is intuitive and useful is provided on a physical, visible display component of a computer system or computing platform, allowing the operations manager to configure summarization snapshot window time periods, add or remove summarized information sources, and to drill down to underlying reports and system configuration options.

Suitable Computing Platform.

Regarding computers for executing the logical processes set forth herein, it will be readily recognized by those skilled in the art that a variety of computers are suitable and will become suitable as memory, processing, and communications capacities of computers and portable devices increases. In such embodiments, the operative invention includes the combination of the programmable computing platform and the programs together. In other embodiments, some or all of the logical processes may be committed to dedicated or specialized electronic circuitry, such as Application Specific Integrated Circuits or programmable logic devices.

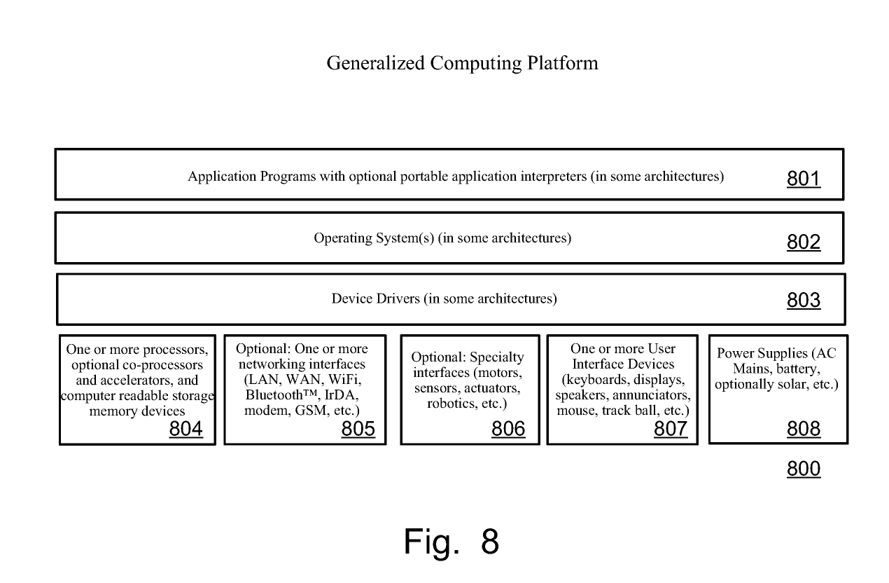

The present invention may be realized for many different processors used in many different computing platforms. FIG. 8 illustrates a generalized computing platform (800), such as common and well-known computing platforms such as “Personal Computers”, web servers such as an IBM iSeries™ server, and portable devices such as personal digital assistants and smart phones, running a popular operating systems (802) such as Microsoft™ Windows™ or IBM™ AIX™, Palm OS™, Microsoft Windows Mobile™, UNIX, LINUX, Google Android™, Apple iPhone iOS™, and others, may be employed to execute one or more application programs to accomplish the computerized methods described herein. Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (801) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (804) accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces (505) may be provided, as well as specialty interfaces for specific applications. If the computing platform is intended to interact with human users, it is provided with one or more user interface devices (807), such as display(s), keyboards, pointing devices, speakers, etc. And, each computing platform requires one or more power supplies (battery, AC mains, solar, etc.).

### CONCLUSION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should also be recognized by those skilled in the art that certain embodiments utilizing a microprocessor executing a logical process may also be realized through customized electronic circuitry performing the same logical process(es).

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. A method for providing an operations management dashboard in an enterprise computing environment, the method comprising:
receiving identity management information from a plurality of information sources by an aggregator portion of a computing system wherein the computing system comprises a processor performing a logical process, an electronic circuit for performing a logical operation, or a combination of a processor and an electronic circuit;
aggregating by the aggregator portion the identity management information according to at least one operations manager preference over a specified snapshot window period of time;
creating a graphical user interface containing the aggregation of identity management information; and
displaying the graphical user interface on a physical, visible display component of a computer system or computing platform.

2. The method as set forth in claim 1 wherein the information sources comprises an Authoritative Source of Record (ASOR) information source.

3. The method as set forth in claim 1 wherein the information sources comprises one or more sources selected from the group consisting of an Identity Management system, an Identity and Access Management system, a system performance monitoring log file, account management records, ticketing records, collaboration records, and badging system activity records, all of which relating to an enterprise computing environment.

4. The method as set forth in claim 1 wherein the graphical user interface comprises one or more hyperlinks, wherein the hyperlinks, when activated by a user, lead to one or more additional graphical user interfaces to display underlying data from one or more information sources within an enterprise computing environment.

5. The method as set forth in claim 4 wherein one or more of the hyperlinks, when activated, retrieve information from one or more information sources external to the computing system.

6. The method as set forth in claim 1 wherein the graphical user interface comprises one or more hyperlinks, wherein the hyperlinks, when activated by a user, lead to one or more additional graphical user interfaces to configure one or more systems producing the information sources within an enterprise computing environment.

7. The method as set forth in claim 1 wherein the graphical user interface comprises one or more hyperlinks, wherein the hyperlinks, when activated by a user, lead to one or more additional graphical user interfaces to configure one or more aggregation control parameters for the aggregating.

8. The method as set forth in claim 7 wherein the aggregation control parameter comprises a value for the snapshot window time period.

9. A computer program product for providing an operations management dashboard in an enterprise computing environment comprising:
a computer readable storage memory device suitable for storing program code;
first program code to receive identity management information from a plurality of information sources;
second program code to aggregate the identity management information according to at least one operations manager preference over a specified snapshot window period of time;
third program code to create a graphical user interface containing the aggregation of identity management information; and
fourth program code to display the graphical user interface on a physical, visible display component of a computer system or computing platform;
wherein the first, second, third and fourth program code

10. The computer program product as set forth in claim 9 wherein the first program code is configured to receive identity management information from at least one information source selected from the group consisting of Authoritative Source of Records (ASOR), an Identity Management system, an Identity and Access Management system, a system performance monitoring log file, account management records, ticketing records, collaboration records, and badging system activity records, all of which information sources relate to an enterprise computing environment.

11. The computer program product as set forth in claim 9 wherein the third program code produces a user interface with one or more hyperlinks which, when activated by a user, lead to one or more additional graphical user interfaces to display underlying data from one or more information sources within an enterprise computing environment.

12. The computer program product as set forth in claim 9 wherein the third program code produces a graphical user interface with one or more hyperlinks which, when activated by a user, lead to one or more additional graphical user interfaces to configure one or more systems producing the information sources within an enterprise computing environment.

13. The computer program product as set forth in claim 9 wherein the third program code produces a graphical user interface with one or more hyperlinks, wherein the hyperlinks, when activated by a user, lead to one or more additional graphical user interfaces to configure one or more aggregation control parameters for the aggregating.

14. The computer program product as set forth in claim 13 wherein the aggregation control parameter comprises a value for the snapshot window time period.

15. A system for providing an operations management dashboard in an enterprise computing environment comprising:
a computer system having at least one logical processing means selected from the group comprising a processor executing software and an electronic circuit;
an information receiver to receive identity management information from a plurality of information sources;
an aggregator to aggregate the identity management information according to at least one operations manager preference over a specified snapshot window period of time; and
a user interface generator to create a graphical user interface containing the aggregation of identity management information, and to display the graphical user interface on a physical, visible display component of a computer system or computing platform.

16. The system as set forth in claim 16 wherein the information receiver is configured to receive identity management information from at least one information source selected from the group consisting of Authoritative Source of Records (ASOR), an Identity Management system, an Identity and Access Management system, a system performance monitoring log file, account management records, ticketing records, collaboration records, and badging system activity records, all of which information sources relate to an enterprise computing environment.

17. The system as set forth in claim 16 wherein the user interface generator is configured to produce a user interface with one or more hyperlinks which, when activated by a user, lead to one or more additional graphical user interfaces to display underlying data from one or more information sources within an enterprise computing environment.

18. The system as set forth in claim 16 wherein the user interface generator is configured to produce a graphical user interface with one or more hyperlinks which, when activated by a user, lead to one or more additional graphical user interfaces to configure one or more systems producing the information sources within an enterprise computing environment.

19. The system as set forth in claim 16 wherein the user interface generator is configured to produce a graphical user interface with one or more hyperlinks, wherein the hyperlinks, when activated by a user, lead to one or more additional graphical user interfaces to configure one or more aggregation control parameters for the aggregating.

20. The system as set forth in claim 19 wherein the aggregation control parameter comprises a value for the snapshot window time period.
